(19) United States
(12) Patent Application Publication
(10) Pub. No.: US 2015/0253946 A1
(43) Pub. Date: Sep. 10, 2015

(54) METHOD AND APPARATUS FOR TRANSFERRING FILES BASED ON USER INTERACTION

(71) Applicant: Verizon Patent and Licencing Inc., Arlington, VA (US)

(72) Inventor: Arthanari CHANDRASEKARAN, Chennai (IN)

(73) Assignee: Verizon Patent and Licensing Inc., Arlington, VA (US)

(21) Appl. No.: 14/202,417

(22) Filed: Mar. 10, 2014

(51) Int. Cl. G06F 3/0484; H04L 29/08

(52) U.S. Cl. CPC G06F 3/0484; H04L 67/06; H04L 67/10

(57) ABSTRACT

An approach is provided for transferring one or more files to a cloud storage service, a local storage service and/or a file sharing service based on user interaction with the user interface element. The approach involves presenting a user interface element at a device, wherein the user interface element represents a file. The approach also involves receiving an input for specifying an interaction with the user interface element. The approach further involves determining that the interaction indicates a request to initiate a transfer operation between the device and a service. Additionally, the approach involves initiating the transfer operation on the file based on the interaction.

### BACKGROUND INFORMATION

Advancement in technology has led to an increased presence of touch enabled interfaces in communication devices, therefore making it important to incorporate user interactions with the interface elements for uploading or downloading files to enhance user experience. Correspondingly, with the growth of cloud storage services and local storage services, integrating gesture recognition for uploading or downloading of files to such services augments efficiency.

Therefore, there is a need for a system capable of transferring one or more files to a cloud storage service, a local storage service, and/or a file sharing service based on user interaction with the user interface element.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of transferring one or more files to a cloud storage service, a local storage service and/or a file sharing service based on user interaction with the user interface element, according to one embodiment;

FIG. 2 is a diagram of the components of the transfer platform 115, according to one embodiment;

FIG. 3 is a flowchart of a process for transferring one or more files to a cloud storage service, a local storage service and/or a file sharing service based on user interaction with the user interface element, according to one embodiment;

FIG. 4 is a flowchart of a process for determining one or more interactions with at least one user interface element for transferring one or more files to one or more services, according to one embodiment;

FIG. 5 is a flowchart of a process for presenting another user interface element for specifying additional services, according to one embodiment;

FIGS. 6A-6B are diagrams of user interfaces utilized in the process of causing an uploading of one or more files to a configured cloud storage based on the upward direction of the at least one interaction, according to one example embodiment;

FIGS. 7A-7B are diagrams of user interfaces utilized in the process of causing a downloading of one or more files to a local device memory based on the downward direction of the at least one interaction, according to one example embodiment;

FIG. 8 is a diagram of a computer system that can be used to implement various exemplary embodiments;

FIG. 9 is a diagram of a chip set that can be used to implement various exemplary embodiments; and

FIG. 10 is a diagram of a mobile terminal that can be used to implement various exemplary embodiments.

### DESCRIPTION OF THE PREFERRED EMBODIMENT

An apparatus, method, and software for transferring one or more files to a cloud storage service, a local storage service and/or a file sharing service based on user interaction with the user interface element is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the preferred embodiments of the invention.

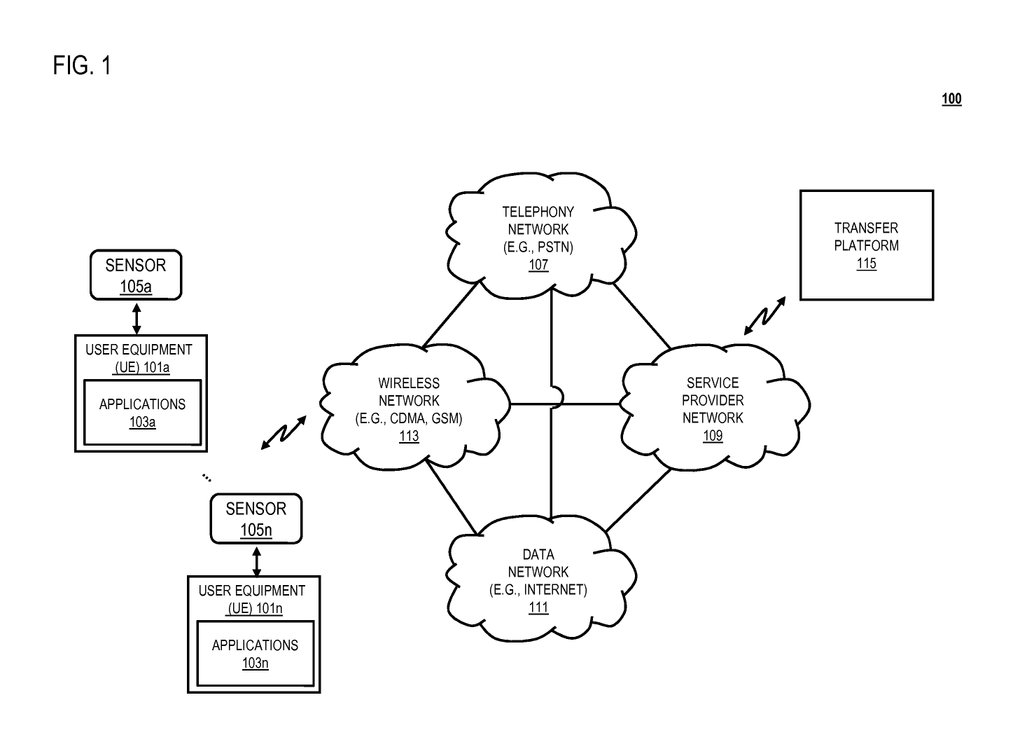

FIG. 1 is a diagram of a system capable of causing a presentation of one or more user interface elements in at least one device, and determining one or more interactions with at least one user interface element to cause a transfer of one or more files to a non-local repository, a local repository, or a combination thereof. As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the transfer platform 115 via network 107-113.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as, location-based services (e.g., providing proximity information), an Internet browser, media applications (e.g., music and/or video streaming, photo exchange, etc.), social networking applications, etc. In one embodiment, the application 103 may be an application that determines a touch-based interaction and/or a gesture-based interaction with the one or more user interface element. In another embodiment, the applications 103 may aid the transfer platform 115 in causing a presentation of multiple display of one or more user interface elements for specifying an uploading of one or more files to a configured cloud storage or a downloading of one or more files to a local repository.

By way of example, the sensors 105 may be any type of sensor. In certain embodiments, the sensors 105 may include, for example, a camera/imaging sensor for gathering image data, an audio recorder for gathering audio data, a global positioning sensor for gathering location data, a network detection sensor for detecting wireless signals or network data, temporal information and the like. In one scenario, the sensors 105 may include location sensors (e.g., GPS), light sensors, oriental sensors, tilt sensors, pressure sensors, audio sensors (e.g., microphone), or receivers for different short-range communications (e.g., Bluetooth, WiFi, etc.). In one embodiment, the sensors 105 may detect user interaction with a user interface generated by the UE 101, applications 103, and/or the transfer platform 115.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions.

In one embodiment, the transfer platform 115 may be a platform with multiple interconnected components. The transfer platform 115 may include multiple servers, intelligent networking devices, computing devices, components and corresponding software for transferring one or more files to a cloud storage service, a local storage service and/or a file sharing service based on user interaction with the user interface element.

In one embodiment, the transfer platform 115 may cause a presentation of a user interface element at a device, wherein the user interface element represents a file. In one scenario, a file may be an audio, a video, an image, a document, etc. In another embodiment, the transfer platform 115 may receive an input for specifying an interaction with the user interface element. In one scenario, a user may be presented with one or more guidance on the ways of interacting with the user interface elements, for instance, a user may be instructed to perform an upward swipe to cause an uploading of a file to a configured cloud storage service. Subsequently, the transfer platform 115 may determine that the interaction indicates a request to initiate a transfer operation between the device and a service. In one scenario, the transfer platform 115 may instruct a user to tilt the UE 101 forward to upload a file to a cloud service or tilt the UE 101 backward to download the file to a local repository. In such manner the transfer platform 115 may acknowledge user gesture for transferring files to one or more storage services. In a further embodiment, the transfer platform 115 may initiate the transfer operation on the file based on the interaction. In one scenario, the transfer platform 115 may cause a downloading of a file to a local device memory based on the downward direction of the at least one interaction. In another scenario, the transfer platform 115 may cause a downloading of a file to a local device memory upon determination that a user is interacting with the hardware button control of the UE 101, for instance, a user may press the volume button in a downward direction to trigger a download to a local memory service. In a further scenario, the transfer platform 115 may process sensors based interaction to cause a transfer of files to at least one service, for instance, one or more sensors 105 may detect a hand gesture in an upward motion made by a user above the screen of the UE 101, whereby the transfer platform 115 may cause an uploading of the file to one or more services.

In one embodiment, the transfer platform 115 may process any direction of the user interaction with the user interface elements. The user interaction may be in an upward direction, downward direction, right direction, left direction, etc. In another embodiment, the transfer platform 115 may determine the direction of the interaction, and may cause an activation of a file transfer based on a predetermined function. In one scenario, a predetermined function may be causing an uploading of files to a file sharing service, for instance, any social media service upon determining that a user swiped in a right-hand direction.

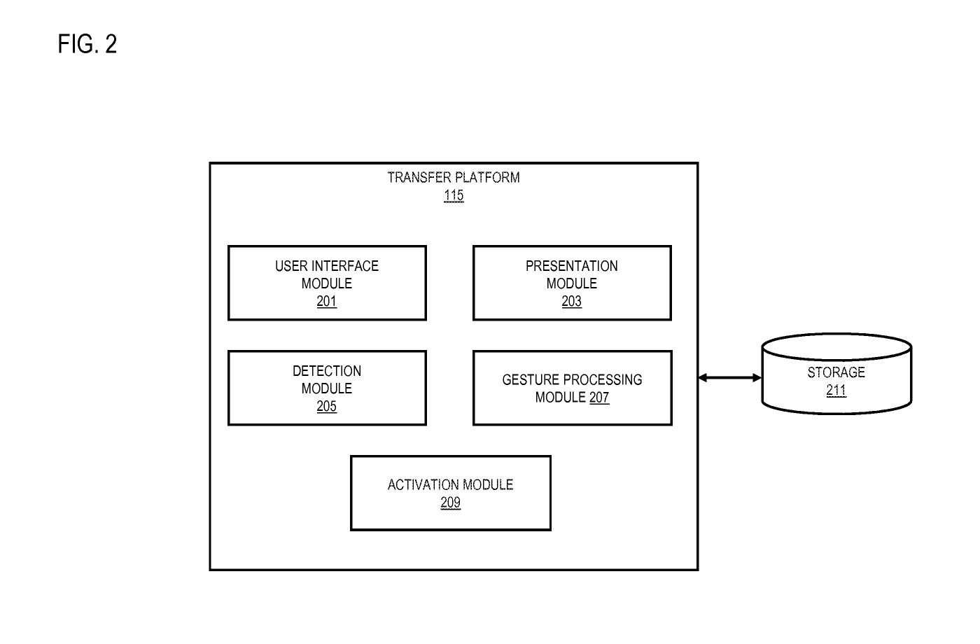

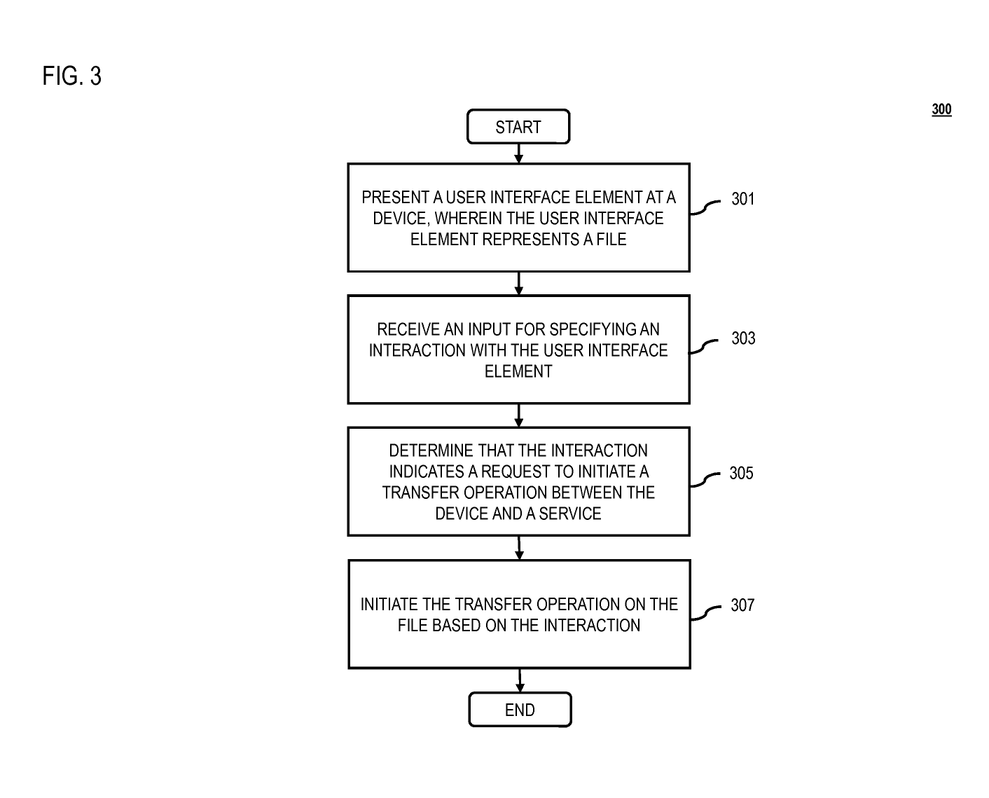

FIG. 2 is a diagram depicting the components of the transfer platform 115, according to one embodiment. The transfer platform 115 includes various executable modules for performing one or more computing, data processing and network based instructions that in combination provide a means for transferring one or more files to a cloud storage service, local storage service and/or a file sharing service based on user interaction with the user interface element, as described in FIGS. 3-5. Such modules can be implemented in hardware, firmware, software or a combination thereof. By way of example, the transfer platform 115 may include a user interface module 201, a presentation module 203, a detection module 205, a gesture processing module 207, and an activation module 209. These modules 201-209 can interact with storage 211 in support of their functions. According to some embodiments, the storage 211 is maintained and updated based, at least in part, on one or more transactions conducted with UE 101 pertaining to various applications and functions of the transfer platform 115.

In one embodiment, the user interface module 201 facilitates generation of various user interface elements for enabling one or more users to interact and select them. In another embodiment, the user interface module 201 may employ various application programming interfaces (APIs) or other function calls corresponding to the application 103 of UE 101, thus enabling the display of graphics primitives for generating the user interface elements. In a further embodiment, the user interface module 201 may provide aesthetic appearance to the user interface elements ensuring convenient display of the content for user convenience.

In one embodiment, the presentation module 203 may cause a display of a user interface element, wherein the user interface element represents a file. In another embodiment, the presentation module 203 may cause a presentation of one or more guidance to a user for selecting multiple files for uploading and/or downloading to the one or more cloud storage service and/or local storage service and/or a file sharing service. In a further embodiment, the presentation module 203 may cause a presentation of another user interface element for specifying a list of available services after a user interacts with one or more files. In one embodiment, the presentation module 203 may present the at least one user with a confirmation of an upload or a download of one or more files to one or more repositories.

In one embodiment, the detection module 205 may recognize one or more interaction with the user interface element to initiate a transfer operation between the device and a service. In another embodiment, the detection module 205 may detect a touch-based input, a gesture-based input, a sensor-based input, or a combination thereof, to cause a transfer of files to one or more services. Subsequently, the detection module 205 may provide the detected information to the gesture processing module 207 for determining the request to initiate the transfer of one or more files.

In one embodiment, the gesture processing module 207 may process the detected information provided by the detection module 205. The gesture processing module 207 may determine the direction of the one or more interaction. In one scenario, the gesture processing module 207 may determine whether the transfer operation is an upload operation or a download operation based on the processing of the detected user interaction with the user interface element. Subsequently, the gesture processing module 207 may provide the activation module 209 with input on directional interaction.

In one embodiment, the activation module 209 may process the input provided by the gesture processing module 207 to cause an uploading of one or more files to a configured cloud storage based on the upward direction of the at least one interaction. In another embodiment, the activation module 209 may cause a downloading of one or more files to a local device memory based on the downward direction of the at least one interaction.

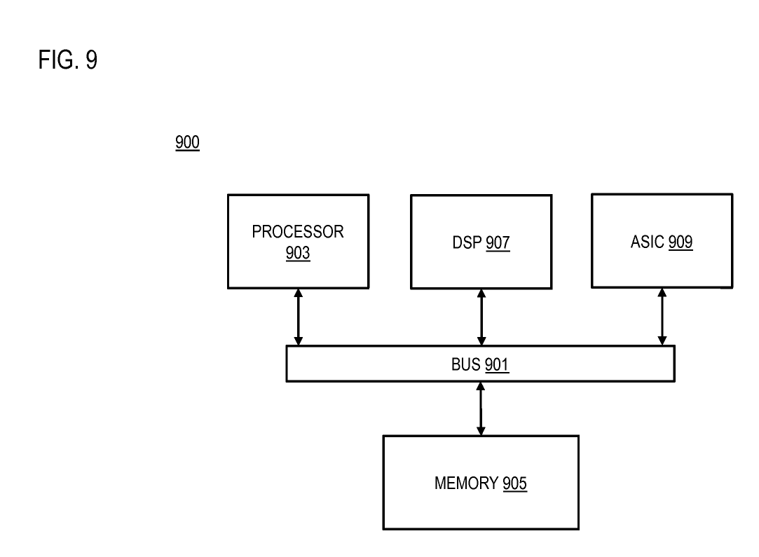

FIG. 3 is a flowchart of a process for transferring one or more files to a cloud storage service, a local storage service and/or a file sharing service based on user interaction with the user interface element, according to one embodiment. In one embodiment, the transfer platform 115 performs the process 300 and is implemented in, for instance, a chip set including a processor and a memory as shown in FIG. 9.

In step 301, the transfer platform 115 may present a user interface element at a device, wherein the user interface element represents a file. In one embodiment, the transfer platform 115 may cause a presentation of one or more user interface elements in at least one device, and may determine one or more interactions with at least one user interface element for transferring one or more files to a non-local repository and/or a local repository.

In step 303, the transfer platform 115 may receive an input for specifying an interaction with the user interface element. In one scenario, the one or more interactions include a touch-based interaction, a gesture-based interaction, or a combination thereof. The transfer platform 115 may cause an activation of a predetermined function based on the direction of the at least one interaction. In one example embodiment, the transfer platform 115 may determine one or more interactions with at least one user interface element for transferring one or more files to one or more service, for example, the transfer platform 115 may cause a downloading of one or more files to a local device memory based on the downward direction of the at least one interaction.

In step 305, the transfer platform 115 may determine that the interaction indicates a request to initiate a transfer operation between the device and a service, wherein the service is a cloud storage service, a file sharing service, or a combination thereof. In one embodiment, the file sharing service may include one or more user interaction with a social networking websites and/or traditional file sharing services. In one scenario, the transfer platform 115 may cause a transfer of one or more files to a non-local repository or a local repository based on one or more interactions by the at least one user with the user interface elements. In another scenario, the transfer platform 115 may cause an uploading of one or more files to a configured cloud storage service based on the upward direction of the at least one interaction. In one example embodiment, the transfer platform 115 may upload one or more files to a social networking service, wherein the one or more files may include, images, videos, documents, etc.

In step 307, the transfer platform 115 may initiate the transfer operation on the file based on the interaction. In one embodiment, an association between the interaction and the service is preconfigured by a user, a service provider, or a combination thereof. In one embodiment, the user and/or the service provider may predetermine a function based on the direction of the at least one interaction. The transfer platform 115 may determine the direction of one or more interactions and causes an activation of a predetermined function based on the direction of the at least one interaction. In one scenario, a user may tilt his/her UE 101 forward whereby the transfer platform 115 may cause an uploading of the selected files to a cloud storage service, such transfer of files based on gesture based interaction may be preconfigured by a user and/or a service provider.

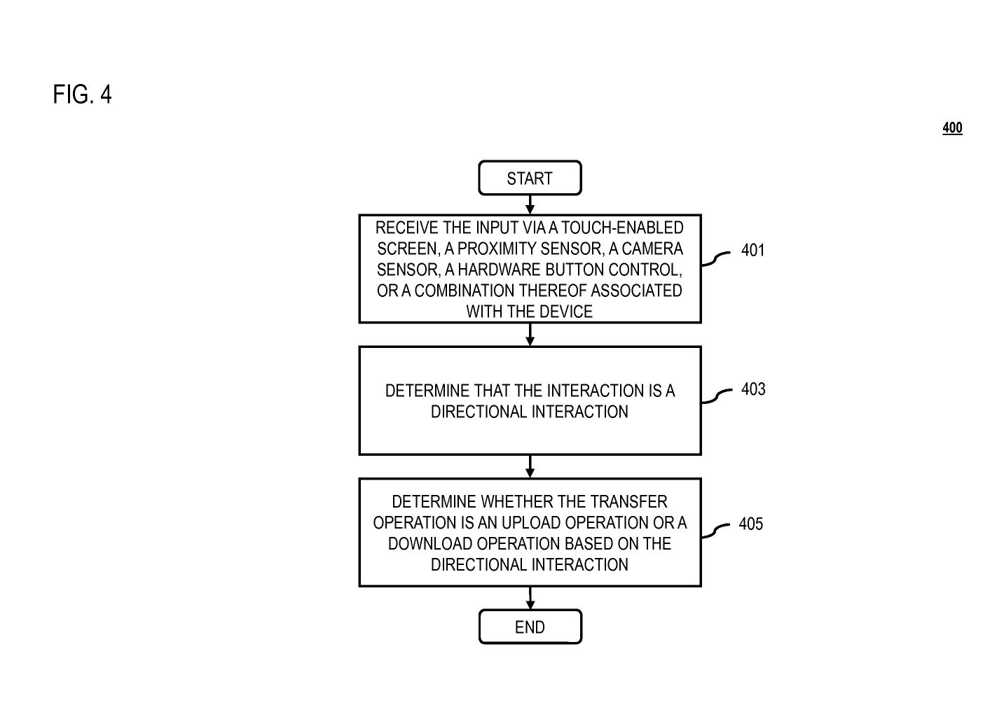

FIG. 4 is a flowchart of a process for determining one or more interactions with at least one user interface element for transferring one or more files to one or more services, according to one embodiment. In one embodiment, the transfer platform 115 performs the process 400 and is implemented in, for instance, a chip set including a processor and a memory as shown in FIG. 9.

In step 401, the transfer platform 115 may receive an input via a touch-enabled screen, a proximity sensor, a camera sensor, a hardware button control, or a combination thereof associated with the device. In one example embodiment, the transfer platform 115 may determine any sensor based interaction via one or more tilt sensors, tactile sensors, pressure sensors, audio sensors, etc., for causing a transfer of one or more files. In another example embodiment, the transfer platform 115 may determine one or more interaction with a hardware button control, for instance, a user may press the volume button of a UE 101 either in an upward direction or in a downward direction to cause an uploading or downloading of the selected files.

In step 403, the transfer platform 115 may determine that the interaction is a directional interaction, wherein the directional interaction includes an upward directional interaction and a downward directional interaction, and wherein the upward directional interaction indicates the upload operation and the downward directional interaction indicates the download operation. In one embodiment, the transfer platform 115 may cause an uploading of one or more files to a configured cloud storage based on the upward motion on the touch enabled screen. In another embodiment, the transfer platform 115 may cause a downloading of one or more files to a local device memory based on the downward motion.

In step 405, the transfer platform 115 may determine whether the transfer operation is an upload operation or a download operation based on the directional interaction. In one scenario, the transfer platform 115 may determine the direction of the touch-based interaction and/or a gesture-based interaction. Subsequently, the transfer platform 115 causes a transfer of one or more selected files to the one or more services based, at least in part, on the direction of the interaction.

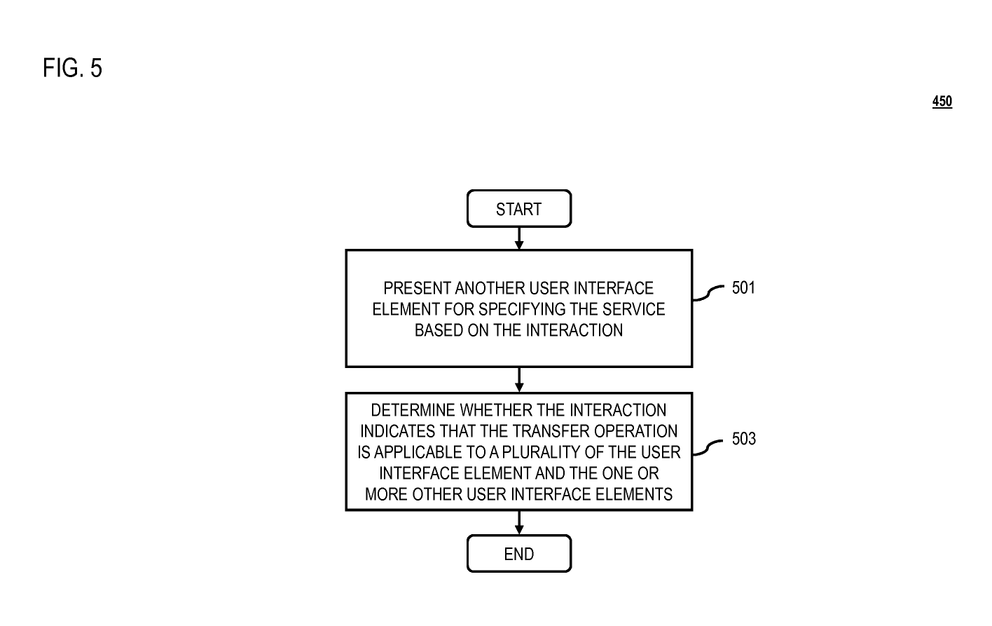

FIG. 5 is a flowchart of a process for presenting another user interface element for specifying additional services, according to one embodiment. In one embodiment, the transfer platform 115 performs the process 500 and is implemented in, for instance, a chip set including a processor and a memory as shown in FIG. 9

In step 501, the transfer platform 115 may present another user interface element for specifying the service based on the interaction. In one embodiment, the one or more other user interface elements that represent one or more other files are visible in the display. In one scenario, if multiple files are available in the viewport a user may be presented with a list of available services after interacting with the one or more files. The user may choose multiple files for uploading to a configured cloud storage service and/or downloading to the local storage service.

In step 503, the transfer platform 115 may determine whether the interaction indicates that the transfer operation is applicable to a plurality of the user interface element and the one or more other user interface elements. In one scenario, the transfer platform 115 may cause a presentation of one or more options to the at least one user for selecting multiple files for uploading and/or downloading. In one example embodiment, if multiple files are presented to the user for uploading or downloading, the transfer platform 115 may cause an uploading and/or downloading of multiple files based, at least in part, on the user interaction pursuant to the instructions for uploading and/or downloading multiple files.

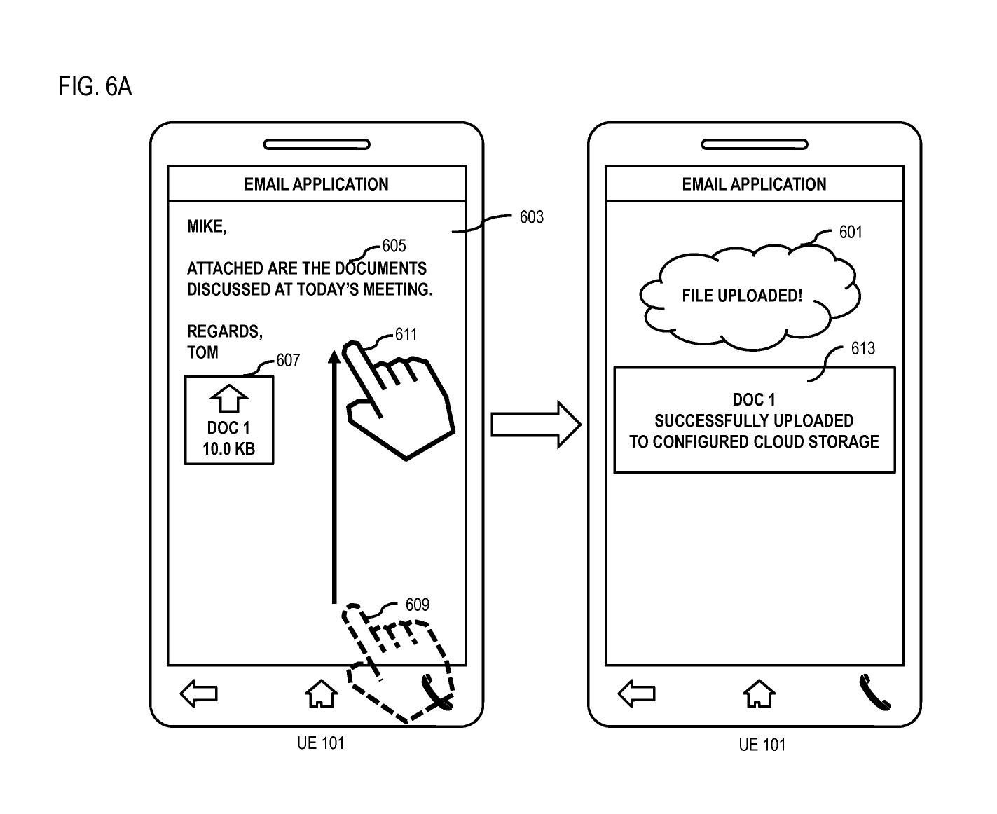

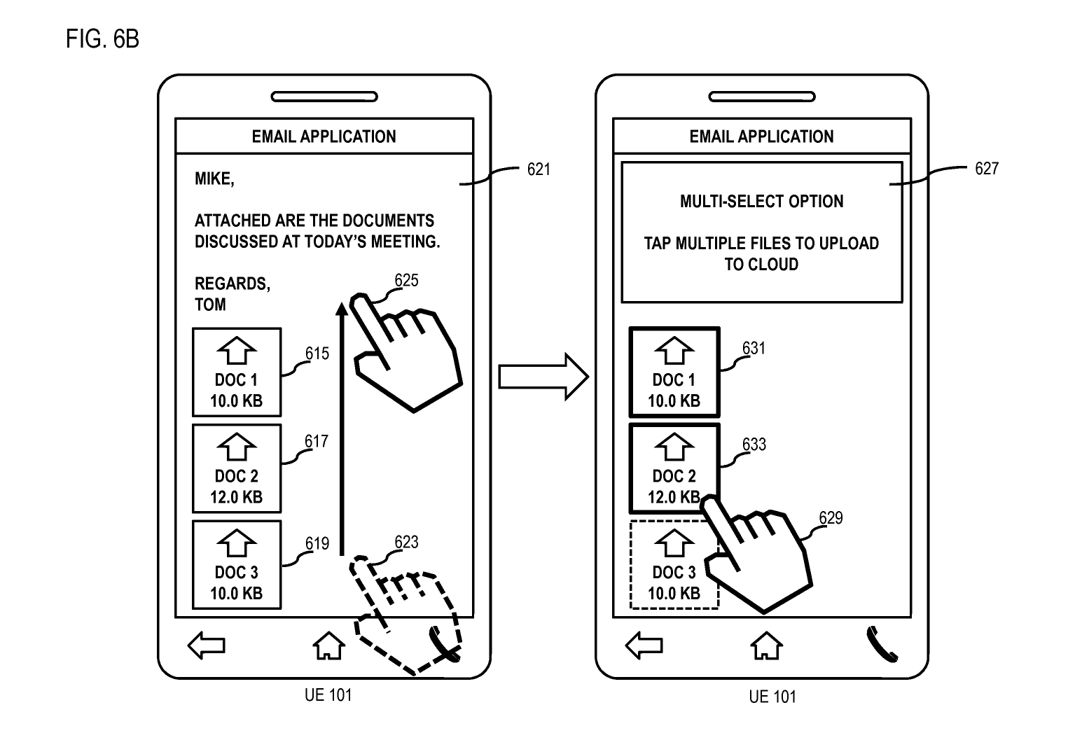

FIGS. 6A-6B are diagrams of user interfaces utilized in the process of causing an uploading of one or more files to a configured cloud storage based on the upward direction of the at least one interaction, according to one example embodiment. In one scenario, FIG. 6A represents a situation whereby a user may have a default cloud storage configured in his/her device (601). The user may be inside any application (603), wherein the user may see one or more user interface elements (605, 607). The user interface elements may be a file or a hyperlink (607) with a pointer to a file. The user may swipe in an upward direction (609, 611) on the touch enabled screen to trigger cloud storage. Subsequently, the at least one file visible in the view port (607) may be uploaded to the configured cloud storage (601). A user may be notified upon successful uploading of one or more files to the configured cloud storage (613). In another scenario, FIG. 6B represents a user interface utilized in the process of causing a presentation of one or more options to the at least one user for selecting multiple files for uploading to a configured cloud storage. If multiple files are available (615, 617, 619) in the viewport the user may be presented with an option to choose the files with multi select option. In one example embodiment, the user may be inside an application (621), wherein the user may see one or more files (615, 617, 619). The user decides to upload the files whereby the user may perform an upward swipe (623, 625) on the touch enabled screen to trigger cloud storage. Subsequently, the user may be provided with guidance information on how to upload multiple files to the configured cloud storage (627). Then, the user may provide a touch based input for selecting one or more files, for instance, the user may tap (629) the files (631, 633) to upload them to the cloud storage.

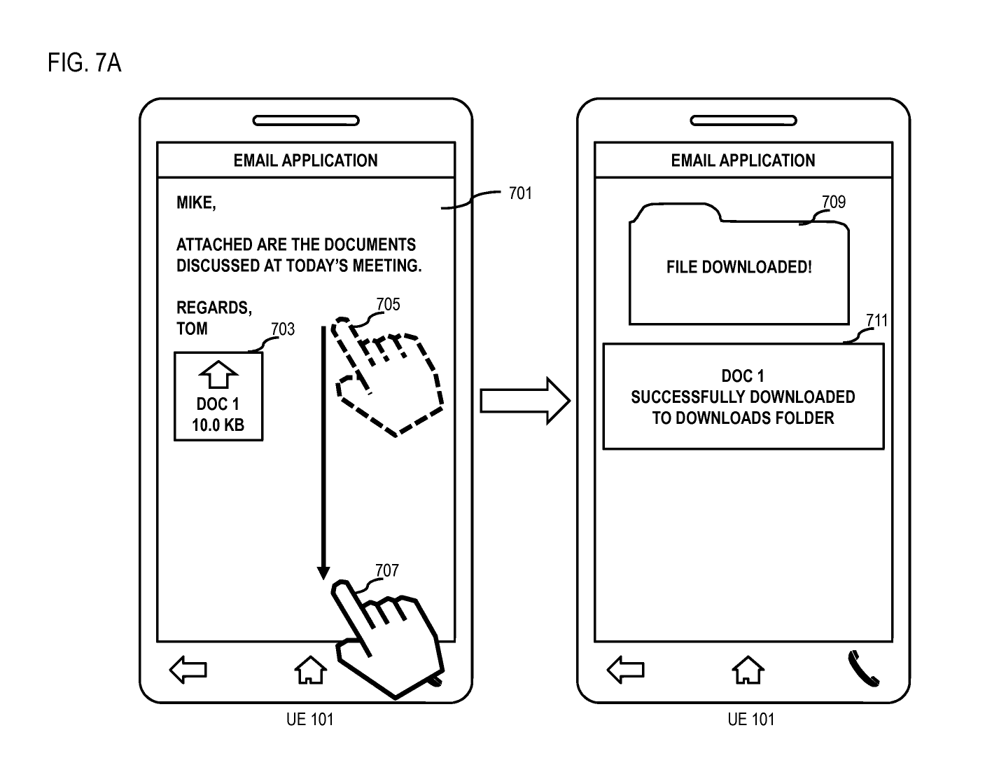

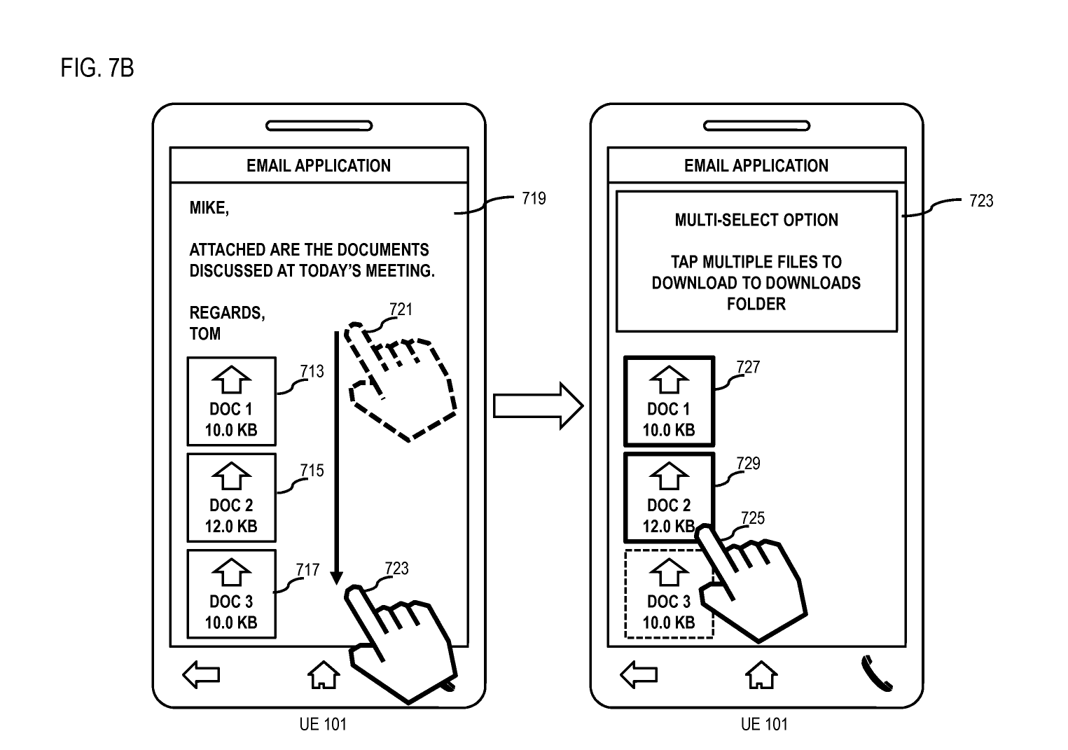

FIGS. 7A-7B are diagrams of user interfaces utilized in the process of causing a downloading of one or more files to a local device memory based on the downward direction of the at least one interaction, according to one example embodiment. In one scenario, FIG. 7A represents a situation wherein a user is inside an application (701) and sees a user interface element (703). The user interface element may be a file (703) or a hyperlink with a pointer to a file, for example, an image or a document (703). The user may swipe down (705,707) in the touch enabled screen and the file visible in the view port (703) will be downloaded to the download folder of the local device memory (709). Subsequently, the user may be provided with a notification that the at least one file has been successfully downloaded to the local device memory (711). In another scenario, FIG. 7B represents a user interface whereby a user is presented with one or more options for selecting multiple files for downloading to a local device memory. If multiple files are available in the viewport (713, 715, 717) the user can be presented with the option to download their files of choice with the multi select option. In one example embodiment, the user may be inside an application (719), wherein the user may see one or more files (713, 715, 717). The user decides to download the first two files whereby the user may perform a downward swipe (721, 723) on the touch enabled screen to trigger storage to a local device memory. Subsequently, the user may be provided with guidance information on how to download multiple files to the local storage (627). Then, the user may provide a touch based input (725) for selecting one or more files, for instance, the user may tap (725) the files he/she wants to download (727, 729) to download them to the local storage.

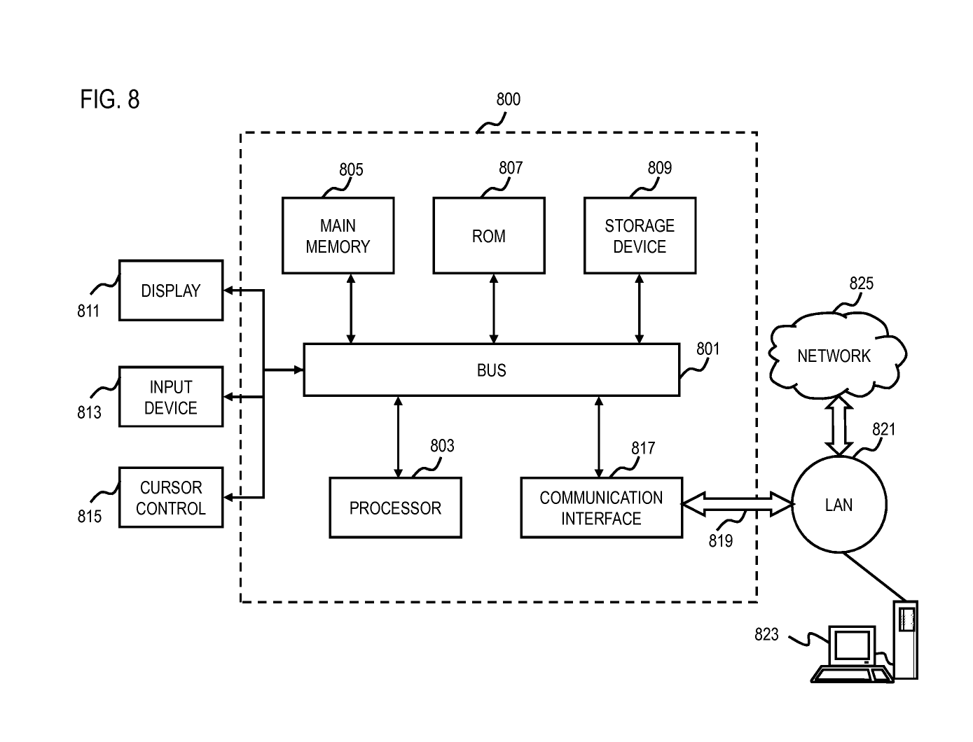

FIG. 8 illustrates computer system 800 that can be used to implement various exemplary embodiments. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multiprocessing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 9 illustrates a chip set 900 that can be used to implement various exemplary embodiments. Chip set 900 is programmed to provide shared user interface view and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of FIGS. 3, 4 and 5.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide a shared user interface view. The memory 905 also stores the data associated with or generated by the execution of the inventive steps.

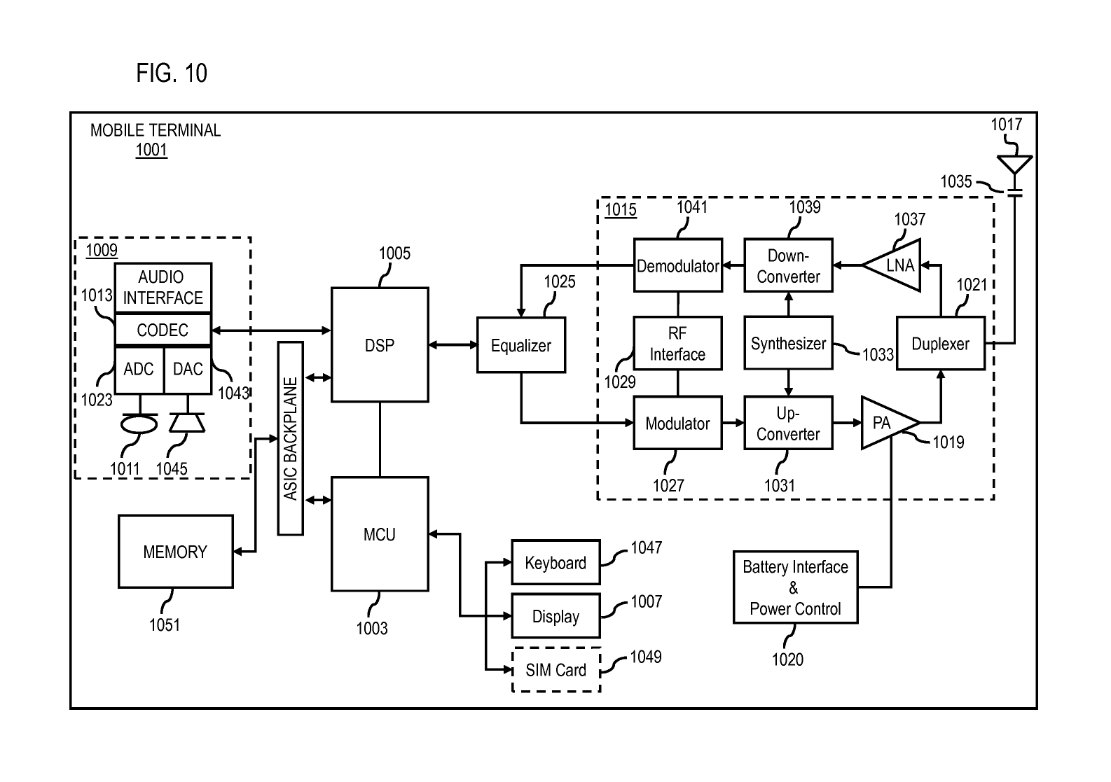

FIG. 10 illustrates a mobile terminal (e.g., handset) 1001 that can be used to implement various exemplary embodiments. In some embodiments, the mobile terminal 1001, or a portion thereof, constitutes a means for performing one or more steps of providing a shared user interface view. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing a shared user interface view. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide a shared user interface view. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
presenting a user interface element at a device, wherein the user interface element represents a file;
receiving an input for specifying an interaction with the user interface element;
determining that the interaction indicates a request to initiate a transfer operation between the device and a service; and
initiating the transfer operation on the file based on the interaction.

2. A method of claim 1, wherein the service is a cloud storage service, a file sharing service, or a combination thereof.

3. A method of claim 1, further comprising:
receiving the input via a touch-enabled screen, a proximity sensor, a camera sensor, a hardware button control, or a combination thereof associated with the device.

4. A method of claim 3, further comprising:
determining that the interaction is a directional interaction; and
determining whether the transfer operation is an upload operation or a download operation based on the directional interaction.

5. A method of claim 4, wherein the directional interaction includes an upward directional interaction and a downward directional interaction, and wherein the upward directional interaction indicates the upload operation and the downward directional interaction indicates the download operation.

6. A method of claim 1, wherein an association between the interaction and the service is preconfigured by a user, a service provider, or a combination thereof.

7. A method of claim 1, further comprising:
presenting another user interface element for specifying the service based on the interaction.

8. A method of claim 1, wherein the user interface element is presented in a display, and wherein one or more other user interface elements that represent one or more other files are visible in the display, the method further comprising:
determining whether the interaction indicates that the transfer operation is applicable to a plurality of the user interface element and the one or more other user interface elements.

9. An apparatus comprising a processor configured to:
present a user interface element at a device, wherein the user interface element represents a file;
receive an input for specifying an interaction with the user interface element;
determine that the interaction indicates a request to initiate a transfer operation between the device and a service; and
initiate the transfer operation on the file based on the interaction.

10. An apparatus of claim 9, wherein the service is a cloud storage service, a file sharing service, or a combination thereof.

11. An apparatus of claim 9, wherein the processor is further configured to:
receive the input via a touch-enabled screen, a proximity sensor, a camera sensor, a hardware button control, or a combination thereof associated with the device.

12. An apparatus of claim 9, wherein the processor is further configured to:
determine that the interaction is a directional interaction; and
determine whether the transfer operation is an upload operation or a download operation based on the directional interaction.

13. An apparatus of claim 12, wherein the directional interaction includes an upward directional interaction and a downward directional interaction, and wherein the upward directional interaction indicates the upload operation and the downward directional interaction indicates the download operation.

14. An apparatus of claim 9, wherein an association between the interaction and the service is preconfigured by a user, a service provider, or a combination thereof.

15. An apparatus of claim 9, wherein the processor is further configured to:
present another user interface element for specifying the service based on the interaction.

16. An apparatus of claim 9, wherein the user interface element is presented in a display, and wherein one or more other user interface elements that represent one or more other files are visible in the display, the method further comprising:
determining whether the interaction indicates that the transfer operation is applicable to a plurality of the user interface element and the one or more other user interface elements.

17. A system comprising a platform configured to:
present a user interface element at a device, wherein the user interface element represents a file;
receive an input for specifying an interaction with the user interface element;
determine that the interaction indicates a request to initiate a transfer operation between the device and a service; and
initiate the transfer operation on the file based on the interaction.

18. A system of claim 17, wherein the platform is further configured to:
receive the input via a touch-enabled screen, a proximity sensor, a camera sensor, a hardware button control, or a combination thereof associated with the device.

19. A system of claim 17, wherein the platform is further configured to:
determine that the interaction is a directional interaction; and
determine whether the transfer operation is an upload operation or a download operation based on the directional interaction.

20. A system of claim 17, wherein the platform is further configured to:
present another user interface element for specifying the service based on the interaction.
